(19) United States
(12) Patent Application Publication
(10) Pub. No.: US 2026/0203780 A1
(43) Pub. Date: Jul. 16, 2026

(54) CUSTOMER NUMBER PREDICTION DEVICE, LEARNING DEVICE, CUSTOMER NUMBER PREDICTION METHOD, LEARNING METHOD, AND PROGRAM

(71) Applicant: NTT, Inc., Tokyo (JP)

(72) Inventors: Jun ITO, Musashino-shi, Tokyo (JP); Hiroyuki SATO, Musashino-shi, Tokyo (JP); Noriko YOKOYAMA, Musashino-shi, Tokyo (JP); Takahiro HATA, Musashino-shi, Tokyo (JP); Masato KAMIYA, Musashino-shi, Tokyo (JP)

(73) Assignee: NTT, Inc., Tokyo (JP)

(21) Appl. No.: 19/133,729

(22) PCT Filed: Dec. 2, 2022
(86) PCT No.: PCT/JP2022/044633

§ 371 Date: May 29, 2025

(51) Int. Cl. G06Q 30/0202; G06N 20/00

(52) U.S. Cl. CPC G06Q 30/0202; G06N 20/00

(57) ABSTRACT

A number of customers prediction device includes an acquisition unit configured to acquire a plurality of explanatory variables including a number of in-building people indicating a number of people existing in the building; and a prediction unit configured to acquire a first number of customers predicted value by inputting the explanatory variable including the number of in-building people to a first model that outputs the first number of customers predicted value that is a predicted value of the number of customers when the explanatory variable including the number of in-building people is input among the plurality of explanatory variables. Further, the prediction unit is configured to acquire a second number of customers predicted value by inputting the explanatory variable not including the number of in-building people to a second model that outputs the second number of customers predicted value.

### TECHNICAL FIELD

The disclosed technology relates to a number of customers prediction device, a learning device, a number of customers prediction method, a learning method, and a computer program.

### BACKGROUND ART

Conventionally, in a restaurant or the like, the number of customers on a future date is predicted on the basis of past payment data recorded by a point of sale (POS) terminal. Further, a technique of enabling the number of customers prediction with higher accuracy by considering not only payment data but also weather data, the number of in-building people in a building in which a restaurant or the like is located, a use rate of the restaurant, and the like. It is known that the number of customers of a restaurant located in a building correlates with the number of in-building people in the building. Among restaurants, in particular, in a company cafeteria, the correlation between the number of in-building people and the number of customers is remarkable, and the number of in-building people is an important explanatory variable in prediction of the number of customers. For example, Non Patent Literature 1 discloses a technique related to application of an individual behavior model to a prediction problem of the number of meals in a company cafeteria by machine learning and an effect analysis thereof.

CITATION LIST

### Non Patent Literature

Non Patent Literature 1: Kiyotaka Matsue, Hideki Noda, and Koichi Kondo, “Application of Individual Behavior Model in Machine Learning Based Cafeteria Visitor Prediction Model and Its Effectiveness Analysis”, The 32nd Annual Conference of the Japanese Society for Artificial Intelligence, 2018 The 32nd Annual Conference of the Japanese Society for Artificial Intelligence, 2018 2018/06/05-2018/06/08

### SUMMARY OF INVENTION

### Technical Problem

However, in a case where an inaccurate number of in-building people is measured due to an influence of a system trouble or the like of an entrance gate of the building, there is a problem that a strong correlation between the number of in-building people and the number of customers is a negative influence, and a number of customers predicted value also becomes an inaccurate value.

In addition, there is a problem that the number of customers predicted value becomes an inaccurate value even in a case where the number of in-building people in the building suddenly changes due to an influence of an event such as a holiday day or a Bon season.

The disclosed technology has been made in view of the above points, and an object thereof is to provide a number of customers prediction device, a learning device, a number of customers prediction method, a learning method, and a program capable of accurately predicting the number of customers of a store located in a building even in a case where the number of in-building people representing the number of people existing in the building changes or in a case where the number of in-building people is inaccurate when predicting the number of customers of the store located in the building.

### Solution to Problem

The first aspect of the present disclosure is a number of customers prediction device that predicts a number of customers of a store located in a building, the number of customers prediction device including: an acquisition unit configured to acquire a plurality of explanatory variables including a number of in-building people indicating a number of people existing in the building; and a prediction unit configured to acquire a first number of customers predicted value by inputting the explanatory variable including the number of in-building people to a first model that outputs the first number of customers predicted value that is a predicted value of the number of customers when the explanatory variable including the number of in-building people is input among the plurality of explanatory variables, acquire a second number of customers predicted value by inputting the explanatory variable not including the number of in-building people to a second model that outputs the second number of customers predicted value that is a predicted value of the number of customers when the explanatory variable not including the number of in-building people is input among the plurality of explanatory variables, and acquire an integrated number of customers predicted value by inputting the plurality of explanatory variables, the first number of customers predicted value, and the second number of customers predicted value to a third model that outputs the integrated number of customers predicted value that is a predicted value of the number of customers in which the first number of customers predicted value and the second number of customers predicted value are integrated when the plurality of explanatory variables, the first number of customers predicted value, and the second number of customers predicted value are input.

The second aspect of the present disclosure is a learning device that learns a model that predicts a number of customers of a store located in a building, the learning device including: a learning data acquisition unit configured to acquire learning data in which a plurality of explanatory variables for learning including a number of in-building people indicating a number of people existing in the building is associated with an actual number of customers; and a learning unit configured to learn, on a basis of the learning data, a first model that outputs a first number of customers predicted value that is a predicted value of the number of customers when the explanatory variable including the number of in-building people is input, a second model that outputs a second number of customers predicted value that is a predicted value of the number of customers when the explanatory variable not including the number of in-building people is input, and a third model that outputs an integrated number of customers predicted value that is a predicted value of the number of customers in which the first number of customers predicted value and the second number of customers predicted value are integrated when the plurality of explanatory variables, the first number of customers predicted value, and the second number of customers predicted value are input.

The third aspect of the present disclosure is a number of customers prediction method that predicts a number of customers of a store located in a building, in which a computer executes processing including: acquiring a plurality of explanatory variables including a number of in-building people indicating a number of people existing in the building; acquiring a first number of customers predicted value by inputting the explanatory variable including the number of in-building people to a first model that outputs the first number of customers predicted value that is a predicted value of the number of customers when the explanatory variable including the number of in-building people is input among the plurality of explanatory variables; acquiring a second number of customers predicted value by inputting the explanatory variable not including the number of in-building people to a second model that outputs the second number of customers predicted value that is a predicted value of the number of customers when the explanatory variable not including the number of in-building people is input among the plurality of explanatory variables; and acquiring an integrated number of customers predicted value by inputting the plurality of explanatory variables, the first number of customers predicted value, and the second number of customers predicted value to a third model that outputs the integrated number of customers predicted value that is a predicted value of the number of customers in which the first number of customers predicted value and the second number of customers predicted value are integrated when the plurality of explanatory variables, the first number of customers predicted value, and the second number of customers predicted value are input.

The fourth aspect of the present disclosure is a learning method for learning a model that predicts a number of customers of a store located in a building, in which a computer executes processing including: acquiring learning data in which a plurality of explanatory variables for learning including a number of in-building people indicating a number of people existing in the building is associated with an actual number of customers; and learning, on a basis of the learning data, a first model that outputs a first number of customers predicted value that is a predicted value of the number of customers when the explanatory variable including the number of in-building people is input, a second model that outputs a second number of customers predicted value that is a predicted value of the number of customers when the explanatory variable not including the number of in-building people is input, and a third model that outputs an integrated number of customers predicted value that is a predicted value of the number of customers in which the first number of customers predicted value and the second number of customers predicted value are integrated when a plurality of the explanatory variables, the first number of customers predicted value, and the second number of customers predicted value are input.

### Advantageous Effects of Invention

According to the disclosed technology, there is an effect of accurately predicting the number of customers of a store located in a building even in a case where the number of in-building people representing the number of people existing in the building changes or in a case where the number of in-building people is inaccurate when predicting the number of customers of the store located in the building.

### BRIEF DESCRIPTION OF DRAWINGS

FIG. 1 is a block diagram illustrating an example of a hardware configuration of a number of customers prediction device according to an embodiment.

FIG. 2 is a block diagram illustrating an example of a functional configuration of the number of customers prediction device according to the embodiment.

FIG. 3 is a diagram illustrating an example of data stored in a data storage unit.

FIG. 4 is a diagram illustrating an example of the data stored in the data storage unit.

FIG. 5 is a diagram illustrating an example of the data stored in the data storage unit.

FIG. 6 is a diagram illustrating an example of the data stored in the data storage unit.

FIG. 7 is a diagram illustrating an example of a feature amount.

FIG. 8 is a diagram for describing an operation of a number of customers prediction device according to a first embodiment.

FIG. 9 is a diagram for describing the operation of the number of customers prediction device according to the first embodiment.

FIG. 10 is a diagram for describing the operation of the number of customers prediction device according to the first embodiment.

FIG. 11 is a diagram illustrating an example of a number of customers prediction system.

FIG. 12 is a diagram illustrating an example of the data stored in the data storage unit.

FIG. 13 is a diagram illustrating an example of the data stored in the data storage unit.

FIG. 14 is a diagram for describing an operation of a number of customers prediction device according to a second embodiment.

FIG. 15 is a diagram for describing the operation of the number of customers prediction device according to the second embodiment.

FIG. 16 is a diagram for describing model assignment for each prediction target day.

FIG. 17 is a diagram illustrating an example of data stored in a data storage unit.

### DESCRIPTION OF EMBODIMENTS

Hereinafter, an example of an embodiment of the disclosed technology will be described with reference to the drawings. Note that in the drawings, the same or equivalent components and portions will be denoted by the same reference numerals. Further, dimensional ratios in the drawings are exaggerated for convenience of description and thus may be different from actual ratios.

### First Embodiment

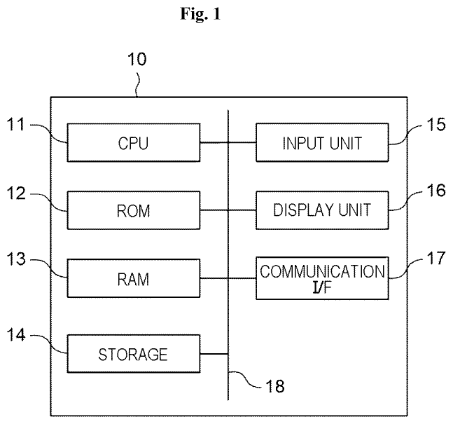

First, a hardware configuration of a number of customers prediction device 10 according to the present embodiment will be described with reference to FIG. 1.

FIG. 1 is a block diagram illustrating an example of a hardware configuration of the number of customers prediction device 10 according to the present embodiment.

As illustrated in FIG. 1, the number of customers prediction device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 18.

The CPU 11 is a central processing unit, and executes various programs and controls each unit. In other words, the CPU 11 reads out a program from the ROM 12 or the storage 14 and executes the program using the RAM 13 as a working area. The CPU 11 controls, in accordance with the program stored in the ROM 12 or the storage 14, each of the components described above and carries out various types of arithmetic processing. In the present embodiment, a learning program and a number of customers prediction program are stored in the ROM 12 or the storage 14.

The ROM 12 stores various programs and various types of data. The RAM 13 temporarily stores the programs and data as a working area. The storage 14 includes a hard disk drive (HDD) or a solid state drive (SSD) and stores various programs including an operating system and various types of data.

The input unit 15 includes a pointing device such as a mouse and a keyboard and is used to perform various inputs to its own device.

The display unit 16 is, for example, a liquid crystal display and displays various types of information. The display unit 16 may also function as the input unit 15 by adopting a touch panel system.

The communication interface 17 is an interface through which its own device communicates with another external device. For the communication, for example, wired communication standards such as Ethernet (registered trademark) or fiber distributed data interface (FDDI), or wireless communication standards such as 4G, 5G, or Wi-Fi (registered trademark) are used.

For example, a general-purpose computer device such as a server computer or personal computer (PC) is applied to the number of customers prediction device 10 according to the present embodiment.

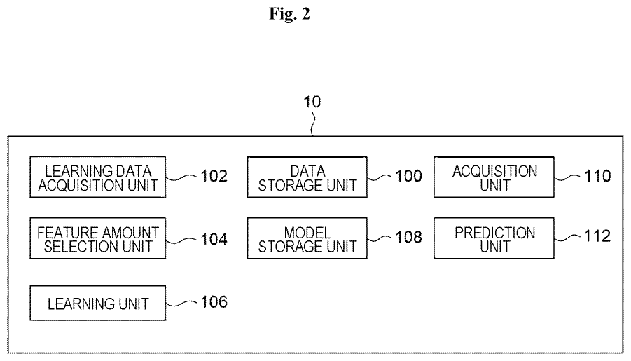

Next, a functional configuration of the number of customers prediction device 10 will be described with reference to FIG. 2.

FIG. 2 is a block diagram illustrating an example of a functional configuration of the number of customers prediction device 10 according to the present embodiment.

As illustrated in FIG. 2, the number of customers prediction device 10 includes a data storage unit 100, a learning data acquisition unit 102, a feature amount selection unit 104, a learning unit 106, a model storage unit 108, an acquisition unit 110, and a prediction unit 112 as a functional configuration. Each functional configuration is achieved by the CPU 11 reading the learning program and the number of customers prediction program stored in the ROM 12 or the storage 14, loading the programs to the RAM 13, and executing the programs.

The number of customers prediction device 10 predicts the number of customers of a store located in a building. Note that, hereinafter, a prediction result of the number of customers at the store is also referred to as a number of customers predicted value. In obtaining the number of customers predicted value, the number of in-building people representing the number of people existing in the building is used. A change in the number of in-building people affects the number of customers predicted value. The number of customers prediction device 10 of the present embodiment accurately predicts the number of customers of the store located in the building even in a case where the number of in-building people, which represents the number of people existing in the building, changes. Hereinafter, specific description will be given.

The data storage unit 100 stores a past number of customers predicted value predicted by the prediction unit 112 to be described below, a number of customers actual value that is an actual achievement of the number of customers, various data used as explanatory variables at the time of prediction, and the like.

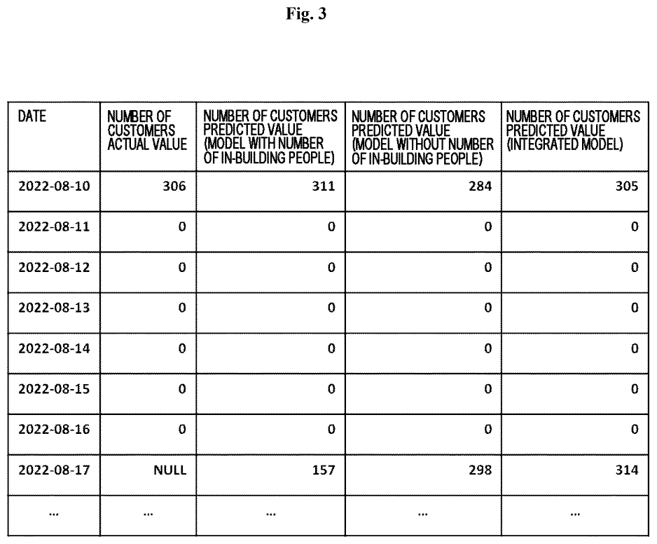

FIG. 3 is an example of number of customers data stored in the data storage unit 100. As illustrated in FIG. 3, in the number of customers data, the number of customers actual value, the number of customers predicted value (a model with the number of in-building people), and the number of customers predicted value (a model without the number of in-building people), and the number of customers predicted value (integrated model) are associated with one another for each date.

The number of customers predicted value (the model with the number of in-building people) illustrated in FIG. 3 is data output from the model with the number of in-building people to be described below. Furthermore, the number of customers predicted value (the model without the number of in-building people) is data output from the model without the number of in-building people to be described below. Furthermore, the number of customers predicted value (integrated model) is data obtained by using the integrated model to be described below. A missing value included in the number of customers data is expressed by “NULL”, indicating that the number of customers actual value of “2022-08-17” is unmeasured, for example.

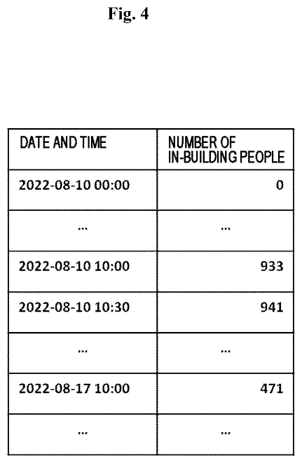

FIG. 4 is an example of the number of in-building people data stored in the data storage unit 100. As illustrated in FIG. 4, the number in-building people data has the number of in-building people for each date and time. In the example illustrated in FIG. 4, a record is stored every 30 minutes, but a time interval may be arbitrary.

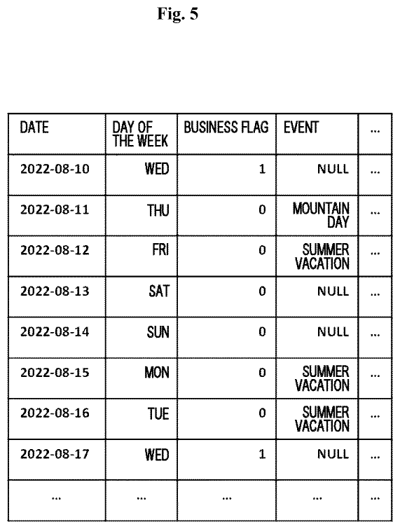

FIG. 5 is an example of event data stored in the data storage unit 100. In the event data, information of a day of the week, a business flag, an event, and the like is associated with each date. The business flag is expressed by, for example, 1 for a business day and 0 for a non-business day. The event is expressed by, for example, a name of a holiday or a name expressing a temporary holiday such as a summer holiday, and is expressed by NULL or the like when there is no special event. Regarding the event data, information other than those illustrated in FIG. 5 may be expressed.

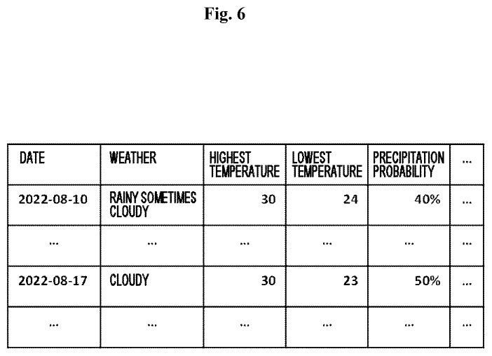

FIG. 6 is an example of weather data stored in the data storage unit 100. In the weather data, pieces of information such as weather, highest temperature, lowest temperature, and precipitation probability are associated with one another for each date. The weather is expressed by, for example, a name such as rainy and sometimes cloudy, or cloudy. The highest temperature or the lowest temperature is expressed by, for example, a numerical value such as 30 or 24. The precipitation probability is expressed by, for example, a percentage such as 40%. Regarding the weather data, information other than those illustrated in FIG. 6 may be expressed.

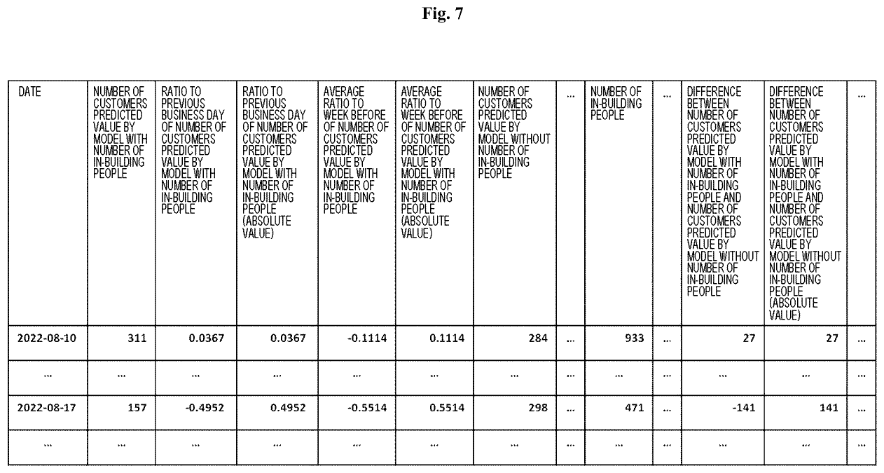

FIG. 7 is an example of feature amounts. For example, the feature amount is information such as the number of customers predicted value by the model with the number of in-building people, the number of customers predicted value by the model without the number of in-building people, or the number of in-building people, of each date. In addition, for example, the feature amount is a ratio to the previous business day, an average ratio to the week before, or the like. Moreover, for example, the feature amounts are information of absolute values thereof. Note that the feature amounts illustrated in FIG. 7 are merely an example, and data recorded in the data storage unit 100 or information obtained by arbitrary calculation using the pieces of data may be used as the feature amounts.

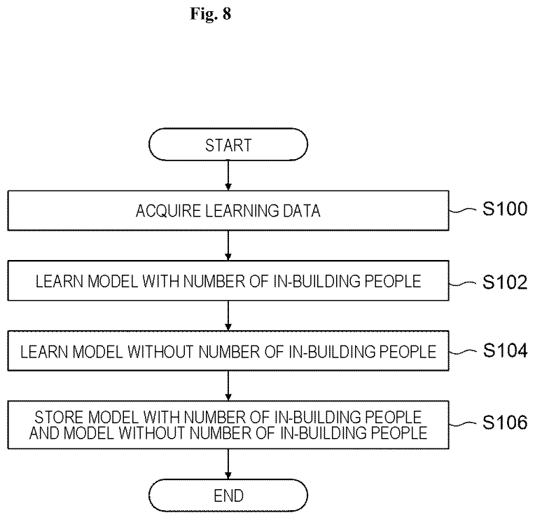

Next, the operation of the number of customers prediction device 10 according to the present embodiment will be described with reference to FIGS. 8 to 10.

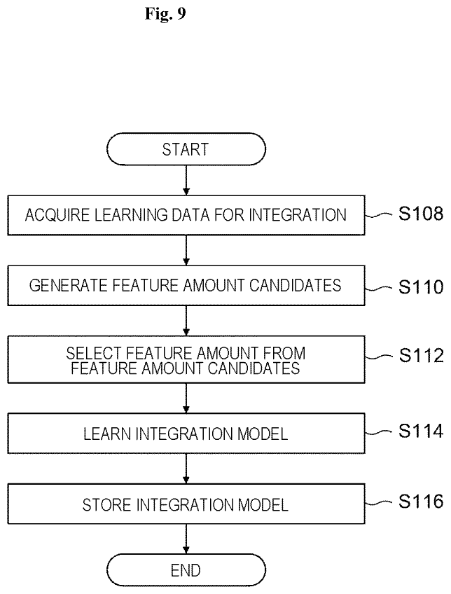

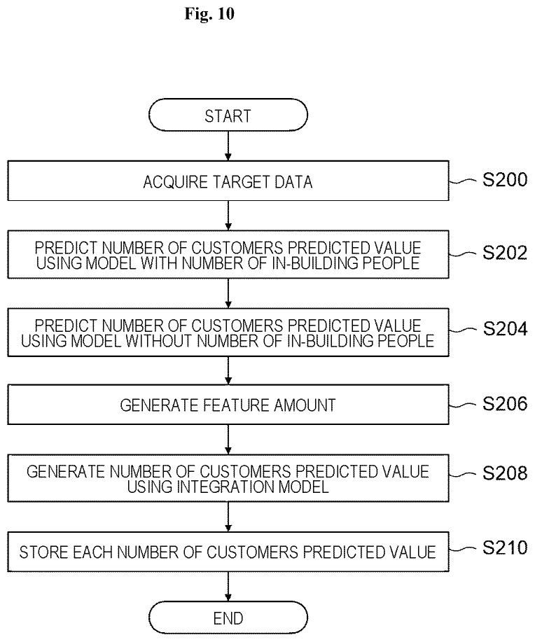

FIGS. 8 and 9 are flowcharts illustrating an example of a flow of processing by the learning program according to the present embodiment. FIG. 10 is a flowchart illustrating an example of a flow of processing by the number of customers prediction program according to the present embodiment. The processing by the learning program is implemented by the CPU 11 of the number of customers prediction device 10 writing the learning program stored in the ROM 12 or the storage 14 to the RAM 13 and executing the learning program. Furthermore, the processing by the number of customers prediction program is implemented by the CPU 11 of the number of customers prediction device 10 writing the number of customers prediction program stored in the ROM 12 or the storage 14 to the RAM 13 and executing the number of customers prediction program.

When receiving a control signal indicating a model learning instruction, the number of customers prediction device 10 executes the processing of FIG. 8.

First, in step S100 of FIG. 8, the CPU 11 acquires learning data from the data stored in the data storage unit 100 as the learning data acquisition unit 102. The learning data is learning data in which a plurality of explanatory variables for learning including the number of in-building people indicating the number of people existing in the building is associated with the actual number of customers. Specifically, the learning data is obtained by connecting the number of customers actual value of the number of customers data, the number of in-building people data, the event data, and the weather data for each date. Since the number of in-building people data is in units of date and time, a value of specific time is adopted as the value of the day. For example, a value at 10:00 every day is set as the number of in-building people on that day.

In step S102, the CPU 11 as the learning unit 106 learns the model with the number of in-building people that outputs the number of customers predicted value that is the predicted value of the number of customers when the number of in-building people representing the number of people existing in the building and external variables are input on the basis of the learning data acquired in step S100. The model with the number of in-building people is an example of a first model, and outputs the number of customers predicted value that is the predicted value of the number of customers when the explanatory variables including the number of in-building people are input. The number of customers predicted value output from the model with the number of in-building people is an example of a first number of customers predicted value. The external variables are variables different from the number of in-building people. The external variables mean data items excluding the number of customers and the number of in-building people, and are for example, an event, weather, and the like. The model with the number of in-building people is implemented by machine learning that solves a regression problem with the number of customers predicted value as an objective variable and the number of in-building people and the external variables as explanatory variables. In the model with the number of in-building people, the number of in-building people is included in the explanatory variable, unlike the model without the number of in-building people to be described below.

In step S104, the CPU 11 as the learning unit 106 learns the model without the number of in-building people that outputs the number of customers predicted value when the external variables are input on the basis of the learning data acquired in step S100. The model without the number of in-building people is an example of a second model, and outputs the number of customers predicted value that is the predicted value of the number of customers when the explanatory variables not including the number of in-building people are input. The number of customers predicted value output from the model without the number of in-building people is an example of a second number of customers predicted value. The model without the number of in-building people is implemented by machine learning that solves a regression problem with the number of customers predicted value as an objective variable and the external variables as explanatory variables. In the model without the number of in-building people, the number of in-building people is not included in the explanatory variable, unlike the model with the number of in-building people.

In step S106, the CPU 11 as the learning unit 106 causes the model storage unit 108 to store the model with the number of in-building people obtained in step S102 and the model without the number of in-building people obtained in step S104.

Next, the number of customers prediction device 10 executes the processing of FIG. 9.

First, in step S108 of FIG. 9, the CPU 11 as the learning unit 106 acquires the learning data for integration from the data stored in the data storage unit 100. Although the learning data for integration is similar to the learning data described above, the learning data for integration is different in including not only the number of customers actual value but also the number of customers predicted values output from the model with the number of in-building people and the model without the number of in-building people. Note that the number of customers predicted values output from the model with the number of in-building people and the model without the number of in-building people are used as the explanatory variables of the integrated model to be described below. Furthermore, the learning data for integration is an example of the learning data in which the feature amount for learning related to the number of customers is associated with the number of customers actual value that is the actual number of customers. These model with the number of in-building people, model without the number of in-building people, and integrated model can be regarded as one model.

In step S110, the CPU 11 as the feature amount selection unit 104 creates a feature amount candidate by calculation using the learning data for integration acquired in step S108 described above. The feature amount selection unit 104 generates a plurality of feature amount candidates as illustrated in FIG. 7, for example, on the basis of the learning data for integration extracted from the data stored in the data storage unit 100. Therefore, the calculation means, for example, calculating the ratio to the previous business day, calculating the average ratio to the week before, or taking the absolute value of the value. For a single data item (for example, the number of in-building people), the feature amount selection unit 104 may calculate the feature amount candidate by comparing the data item with the past (for example, the ratio to the previous business day), or may generate the feature amount candidate by executing four arithmetic operations or the like with another data item (for example, the highest temperature).

In step S112, the CPU 11 as the feature amount selection unit 104 selects the feature amount with which prediction accuracy of the integrated model becomes high from the feature amount candidates created in step S110. As a method of selecting the feature amount, for example, a method of applying a machine learning method called random forest with the number of customers actual value representing the actual number of customers as an objective variable and the feature amount candidates as explanatory variables, and selecting the feature amount with high Gini importance from among the feature amount candidates is conceivable. Moreover, it is also conceivable to apply a method called Boruta of combining a random forest and a test method to select a statistically significantly necessary feature amount from among the feature amount candidates. Therefore, the selected feature amount is a feature amount selected in advance from the plurality of feature amount candidates so as to reduce a difference between the number of customers predicted value and the actual number of customers becomes small.

In step S114, the CPU 11 as the learning unit 106 learns the integrated model. The integrated model is an example of a third model. The integrated model outputs the number of customers predicted value in which the number of customers predicted value output from the model with the number of in-building people and the number of customers predicted value output from the model without the number of in-building people are integrated when the plurality of explanatory variables, the number of customers predicted value output from the model with the number of in-building people, and the number of customers predicted value output from the model without the number of in-building people are input. The number of customers predicted value output from the integrated model is an example of an integrated number of customers predicted value.

The integrated model is implemented by, for example, a machine learning method for solving a classification problem using which of the model with the number of in-building people and the model without the number of in-building people is to be adopted as an objective variable and the feature amounts as explanatory variables. Alternatively, for example, the integrated model is applied by a machine learning method for solving a regression problem with the number of customers actual value as an objective variable and the feature amounts as explanatory variables. Note that, in a case where the integrated model is implemented by the machine learning method for solving a classification problem, the prediction accuracy of the integrated model means an accuracy rate or the like. Furthermore, in a case where the integrated model is implemented by the machine learning method for solving a regression problem, an absolute mean error, an absolute percentage error, or the like is used as the prediction accuracy of the integrated model.

In step S116, the CPU 11 as the learning unit 106 stores the integrated model obtained in step S114 in the model storage unit 108. Note that, at this time, a predicted feature amount item representing the selected feature amount is also stored in the model storage unit 108 so that the same feature amount can be used when the prediction unit 112 to be described below uses the integrated model.

Next, when receiving a control signal indicating a number of customers prediction instruction, the number of customers prediction device 10 executes number of customers prediction processing of FIG. 10.

In step S200, the CPU 11 as the acquisition unit 110 acquires target data from the data storage unit 100. The target data is data including the plurality of explanatory variables including the number of in-building people indicating the number of people existing in the building, and is the explanatory variables necessary for obtaining the number of customers predicted value in a prediction target period. Therefore, the target data does not include the number of customers actual value that is the objective variable in the prediction target period.

In step S202, the CPU 11 as the prediction unit 112 acquires the number of customers predicted value output from the model with the number of in-building people by inputting the number of in-building people and the external variables among the target data acquired in step S200 to the model with the number of in-building people stored in the model storage unit 108.

In step S204, the CPU 11 as the prediction unit 112 acquires the number of customers predicted value output from the model without the number of in-building people by inputting the external variables among the target data acquired in step S200 to the model without the number of in-building people stored in the model storage unit 108.

In step S206, the CPU 11 as the prediction unit 112 generates the feature amount for the integrated model on the basis of the number of customers predicted value obtained in step S202, the number of customers predicted value obtained in step S204, and the predicted feature amount item stored in the model storage unit 108.

For example, in a case where “the ratio to the previous business day of the number of customers predicted value by the model with the number of in-building people” as illustrated in FIG. 7 is included as one of the predicted feature amount items, the prediction unit 112 calculates the value of the ratio to the previous business day of the number of customers predicted value by the model with the number of in-building people, using the number of customers predicted value by the model with the number of in-building people of the previous business day and the number of customers predicted value by the model with the number of in-building people stored in the data storage unit 100. The feature amount for the integrated model is an example of the feature amount related to the number of customers of the present disclosure.

In step S208, the CPU 11 as the prediction unit 112 acquires the data output from the integrated model by inputting the feature amount for the integrated model generated in step S206 above to the integrated model stored in the model storage unit 108. Note that the data output from the integrated model is data indicating the number of customers predicted value or data indicating which one of the model with the number of in-building people and the model without the number of in-building people is to be adopted. Therefore, in step S208, for example, the prediction unit 112 sets the data indicating the number of customers predicted value output from the integrated model as the final number of customers predicted value.

Alternatively, for example, the prediction unit 112 sets the number of customers predicted value output from the model to be adopted as the final number of customers predicted value on the basis of the data indicating which one of the model with the number of in-building people and the model without the number of in-building people output from the integrated model is to be adopted. Specifically, in the case where the data indicating which one of the model with the number of in-building people and the model without the number of in-building people is to be adopted is output from the integrated model, the integrated model outputs selection information indicating which one of the model with the number of in-building people and the model without the number of in-building people is to be selected when the feature amount is input. The prediction unit 112 selects one of the model with the number of in-building people and the model without the number of in-building people on the basis of the selection information, and sets the number of customers predicted value output from the selected model as the final number of customers predicted value. The final number of customers predicted value is an example of the integrated number of customers predicted value.

In step S210, the CPU 11 as the prediction unit 112 stores each of the number of customers predicted values obtained in steps S202, S204, and S208 in the data storage unit 100. These pieces of data are stored as the number of customers predicted value (the model with the number of in-building people), the number of customers predicted value (the model without the number of in-building people), and the number of customers predicted value (the integrated model) illustrated in FIG. 3 in the data storage unit 100.

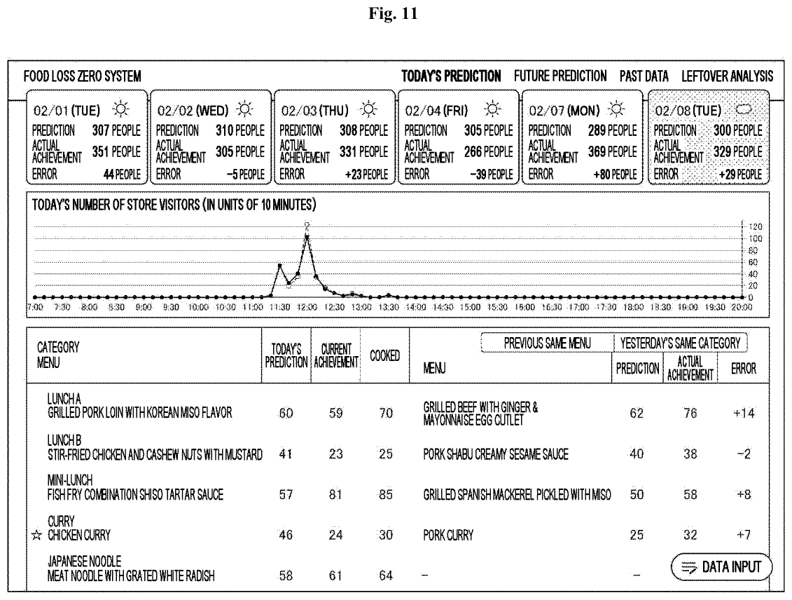

FIG. 11 illustrates an example “food loss zero system” (provisional name) of the number of customers prediction system using the data stored in the data storage unit 100. The number of customers predicted value, the number of customers actual value, and an error value for each date are displayed in a form of cards in an upper part of a screen of FIG. 11.

For example, the data storage unit 100 is constructed as a relational database (RDB), and the number of customers prediction system constructed as a web application can be implemented by referring to data on the RDB through an application programming interface (API) server.

As described above, the number of customers prediction device according to the first embodiment acquires the plurality of explanatory variables including the number of in-building people indicating the number of people existing in a building. The number of customers prediction device acquires the first number of customers predicted value by inputting the explanatory variables including the number of in-building people to the model with the number of in-building people that outputs the first number of customers predicted value that is the predicted value of the number of customers when the explanatory variables including the number of in-building people is input among the plurality of explanatory variables. The number of customers prediction device acquires the second number of customers predicted value by inputting the explanatory variables not including the number of in-building people to the model without the number of in-building people that outputs the second number of customers predicted value that is the predicted value of the number of customers when the explanatory variables not including the number of in-building people is input among the plurality of explanatory variables. The number of customers prediction device acquires the integrated number of customers predicted value by inputting the plurality of explanatory variables, the first number of customers predicted value, and the second number of customers predicted value to the integrated model that outputs the integrated number of customers predicted value that is the predicted value of the number of customers in which the first number of customers predicted value and the second number of customers predicted value are integrated when the plurality of explanatory variables, the first number of customers predicted value, and the second number of customers predicted value are input. Thereby, it is possible to accurately predict the number of customers of a store located in a building even in a case where the number of in-building people representing the number of people existing in the building changes or in a case where the number of in-building people is inaccurate when predicting the number of customers of the store located in the building.

Specifically, according to the number of customers prediction device of the present embodiment, it is possible to perform robust and highly accurate prediction of the number of customers even in a case where the number of in-building people is an inaccurate value or in a case where the number of in-building people suddenly changes by integrating the number of customers predicted value obtained by the model with the number of in-building people and the number of customers predicted value obtained by the model without the number of in-building people using the integrated model.

Furthermore, it is possible to perform robust and highly accurate prediction of the number of customers even in the case where the number of in-building people is inaccurate or in the case where the number of in-building people suddenly changes by calculating the number of customers predicted value, using the feature amount selected from the feature amount candidates as the input of the integrated model. Since the number of in-building people is an important feature amount at a normal time, the number of customers predicted value output from the model with the number of in-building people (or a value close thereto) can be adopted as the final number of customers predicted value. On the other hand, in the case where the number of in-building people is an inaccurate value (or in the case where the number of in-building people suddenly changes), the value (or a value close thereto) of the number of customers predicted value (the model without the number of in-building people) becomes the number of customers predicted value, and the prediction accuracy is improved.

Furthermore, it is possible to suppress over-learning and to make the integrated model robust by selecting the feature amount with which the prediction accuracy of the integrated model becomes high using a method such as random forest or Boruta.

Furthermore, in the above description, as examples of the integrated model, the method of implementing the integrated model as a classification problem of learning which one of the predicted value of the model with the number of in-building people and the model without the number of in-building people is to be adopted, and the method of implementing the integrated model as a regression problem of directly obtaining the number of customers predicted value on the basis of the feature amount are given. Therefore, it is possible to adopt either method with high prediction accuracy.

### Second Embodiment

Next, a second embodiment will be described. The second embodiment is different from the first embodiment in selecting a model to be used for each prediction target day according to an acquisition situation of external variables, and outputting a number of customers predicted value output from the selected model. The model of the second embodiment includes a plurality of models. Note that a number of customers prediction device according to the second embodiment has a configuration similar to that of the first embodiment, and the same reference numerals are given and description thereof is omitted.

To predict the number of customers by using the external variables such as weather data as explanatory variables, it is necessary to acquire values of the external variables in advance for a desired period for which a prediction result is desired to be obtained, that is, a prediction target period. Therefore, there is a problem that the number of customers cannot be predicted in a case where a period in which the external variables can be acquired is less than the prediction target period or in a case where there is a difference in the period in which the external variable can be acquired for each external variable to be handled.

For example, in a case where it is desired to obtain prediction results for the next two weeks, it is assumed that the weather data can be obtained only up to the next week due to convenience of a weather forecast system. In this case, since there is no weather data for the second week, there is a problem that only the number of customers for the next week can be predicted. Moreover, if the period during which the number of in-building people in a building where a restaurant is located can be acquired is up to the next day, a predictable period is further shortened to the next day.

A number of customers prediction device according to the second embodiment has been made in view of the above points, and enables prediction of the number of customers with high prediction accuracy in an arbitrary prediction target period regardless of the number of in-building people or the period in which the external variables can be acquired. Note that, in the second embodiment, data obtained by combining the number of in-building people and the external variables is simply referred to as “input information”.

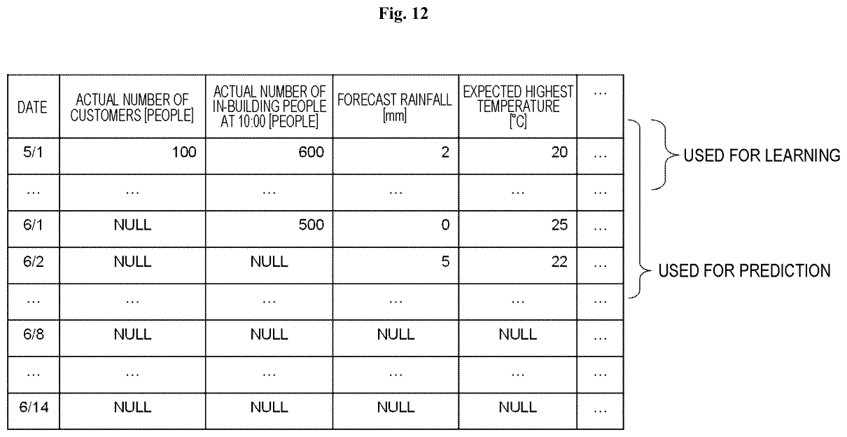

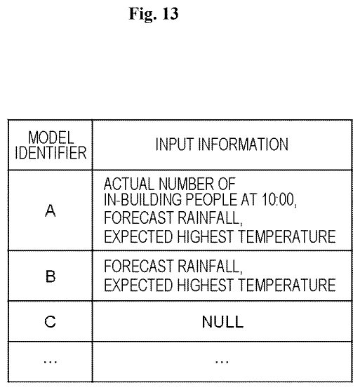

FIGS. 12 and 13 are examples of data stored in a data storage unit 100. FIG. 12 is an example of learning data. FIG. 13 illustrates an example of a model master. As illustrated in FIG. 13, the model master indicates information of a plurality of models A, B, C, . . . , and the plurality of models A, B, and C indicates what input information is input. The input information is also feature amounts related to the explanatory variables and the number of customers.

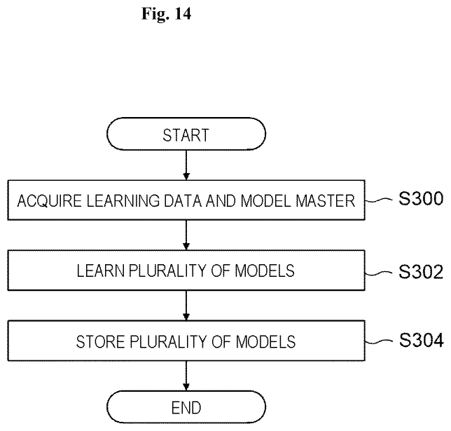

When receiving a control signal indicating a model learning instruction, the number of customers prediction device 10 executes learning processing of FIG. 14.

First, in step S300 of FIG. 14, a CPU 11 as a learning data acquisition unit 102 acquires the learning data and the model master from the data stored in the data storage unit 100.

In step S302, the CPU 11 as a learning unit 106 learns the plurality of models with reference to the model master acquired in step S300. Specifically, the learning unit 106 reads a list of the input information specified after a “model identifier” from the model master illustrated in FIG. 13, extracts “actual number of customers” and items specified in the list of the input information from the learning data, and performs supervised learning with the “actual number of customers” as an objective variable and the “input information” as the explanatory variables. Note that, since the day to be predicted is the number of customers in the future from a reference time point, the past “actual number of customers” older than the reference time point may be included in the explanatory variables. Therefore, in a case where the input information of the model master in FIG. 13 is missing (for example, the model C), a model having only the “actual number of customers” in the past from the reference time point as the explanatory variable is learned.

In step S304, the CPU 11 as the learning unit 106 causes the model storage unit 108 to store the plurality of models obtained in step S302.

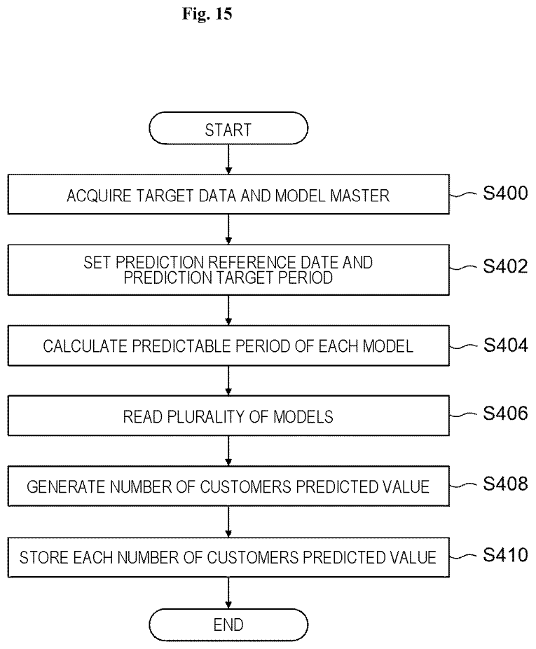

Next, when receiving a control signal indicating a number of customers prediction instruction, the number of customers prediction device 10 executes number of customers prediction processing of FIG. 15.

First, in step S400 of FIG. 15, the CPU 11 as the prediction unit 112 acquires the target data and the model master from the data storage unit 100. Note that the target data is data (specifically, data other than NULL) obtained up to the present time among the data illustrated in FIG. 12.

In step S402, the CPU 11 as the prediction unit 112 sets a prediction reference date and the prediction target period on the basis of the acquisition situation of the target data obtained in step S400.

For example, as illustrated in FIG. 12, in a case where missing information of the “actual number of customers”, which is also a prediction target, starts from 6/1, the prediction unit 112 sets 6/1 as the prediction reference date. Furthermore, as illustrated in FIG. 12, in a case where the date on which the data exists is up to 6/14, the prediction unit 112 sets 6/1 to 6/14 as the prediction target period.

In step S404, the CPU 11 as the prediction unit 112 calculates the predictable period of each model on the basis of a missing situation of the input information of the target data obtained in step S400.

For example, in a case of a model identifier A in the model master in FIG. 13, it is only 6/1 in the prediction target period where values of “actual number of in-building people at 10:00”, “forecast rainfall”, and “expected highest temperature” recorded as the input information exist in FIG. 12. Therefore, the prediction unit 112 sets the predictable period of the model A to 6/1.

Similarly, as illustrated in FIG. 12, it is the period from 6/2 to 6/7 where only the “forecast rainfall” and the “expected highest temperature”, which are the input information of the model B in FIG. 13, exist. Therefore, the prediction unit 112 sets the predictable period of the model B from 6/2 to 6/7.

Finally, as illustrated in FIG. 12, in the period from 6/8 to 6/14, the input information such as the “actual number of in-building people at 10:00”, the “forecast rainfall”, and the “expected highest temperature” cannot be acquired. Therefore, the prediction unit 112 sets the prediction period of the model C (FIG. 13 illustrates the input information “NULL”) having only the actual number of customers as the input information from 6/8 to 6/14.

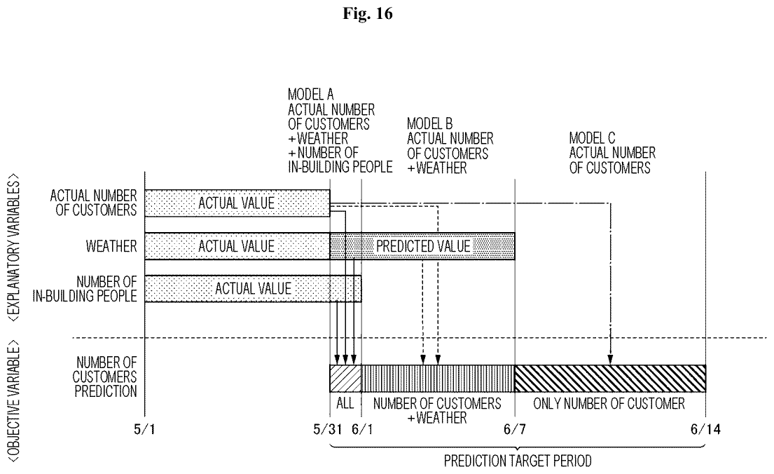

FIG. 16 is a conceptual diagram of the models used for each prediction target day. As illustrated in FIG. 16, the prediction target period varies depending on the models A, B, and C.

In step S406, the CPU 11 as the prediction unit 112 selects the model to be used for each prediction target day according to the predictable period of each model calculated in step S404. Therefore, the model to be used for each prediction target day is selected according to the acquisition situation of the input information input to the plurality of models.

In step S408, the CPU 11 as the prediction unit 112 causes the model selected in step S406 to output the number of customers predicted value. Specifically, the prediction unit 112 inputs the variables recorded in the “input information” and the “actual number of customers” for each “model identifier” of the model master illustrated in FIG. 13. For example, in the case where the “model identifier” is A, the items of the “actual number of customers”, the “actual number of in-building people at 10:00”, the “forecast rainfall”, and the “expected highest temperature” in FIG. 12 are input to the model A.

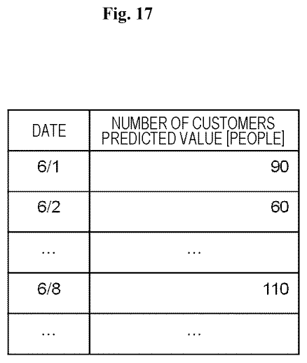

In step S410, the CPU 11 integrates the number of customers predicted value for each prediction target day obtained in step S408 as the prediction unit 112. Specifically, the integration result as illustrated in FIG. 17 is obtained by adopting the output of model A on 6/1, the output of model B from 6/2 to 6/7, and the output of model C from 6/8 to 6/14. Furthermore, the prediction unit 112 outputs the integration result as illustrated in FIG. 17 to the data storage unit 100. Note that the integration result as illustrated in FIG. 17 is an example of the integrated number of customers predicted value.

Furthermore, as another aspect of the prediction unit 112, in the processing of step S404 described above, a prediction error of each model may be compared for each relative number of elapsed days from a reference date, and the prediction period may be set such that a model with a smaller error is responsible for prediction of an appropriate date.

Specifically, first, the reference date is set by going back to the past by a predetermined period longer than the number of days of the prediction target period, and past data older than the reference date is input to each model, so that the number of customers predicted value expected for the prediction target period from the reference date toward the future is obtained as output. Next, an error between the expected number of customers predicted value and the actual number of customers on the same day is calculated for each model for each number of elapsed days from the reference date. Then, the predictable period is set such that the model with the smallest error is responsible for prediction on a date on which the number of elapsed days from the reference date is equal to the number of elapsed days from the prediction date.

For example, in a case where the reference date is set to 5/18, the data obtained at that time is input to each model, and the expected number of customers predicted value from 5/18 to 5/31 is obtained as output. Subsequently, an error in the actual number of customers on the same day as the number of customers expected in each model is calculated every day from 5/18 to 5/31. When 5/18 to 5/31 is regarded as the relative number of days from the reference date, the error from the first day to the fourteenth day is obtained for each model. It is assumed that the errors of the respective models are compared from the first day to the fourteenth day. In this case, it is assumed that the error of the model A is minimized only on the first day, the error of the model B is minimized from the second day to the third day and from the sixth day to the seventh day, and the error of the model C is minimized from the fourth day to the fifth day and from the eighth day to the fourteenth day. In this case, when the prediction period is set from the prediction date of 6/1, 6/1 is set for the model A, the periods from 6/2 to 6/3 and from 6/6 to 6/7 are set for the model B, and the periods from 6/4 to 6/5 and from 6/8 to 6/14 are set for the model C.

Note that a statistical index may be treated as the error, such as by sequentially changing the above-described reference date in a form of 5/1 to 5/18, obtaining the actual numbers of customers of the same days as the expected numbers of customers of 18 times in respective relative numbers of elapsed days, and calculating the error.

In the case of the above example, in step S408 and step S410, the integration result as illustrated in FIG. 17 is obtained by adopting the output of the model A on 6/1, the output of the model B from 6/2 to 6/3, the output of the model C from 6/4 to 6/5, the output of the model B from 6/6 to 6/7, and the output of the model C from 6/8 to 6/14.

As described above, by switching the model according to the difference in the period in which the input information is obtained, it is possible to implement the prediction of the number of customers in the period according to a demand while improving the prediction accuracy in the period in which the external variables are obtained, and to provide convenience.

As described above, the number of customers prediction device according to the second embodiment uses the plurality of models when acquiring the final number of customers predicted value, selects the model to be used for each prediction target day according to the acquisition situation of the input information input to the plurality of models, and outputs the predicted value of the number of customers output from the selected model as the final number of customers predicted value. As a result, it is possible to implement the prediction of the number of customers in the period according to the demand while improving the prediction accuracy in the period in which the input information is obtained.

Furthermore, it is possible to improve the prediction accuracy by comparing the prediction accuracies of the respective models and adopting the prediction result of the model with high accuracy for each individual prediction target day.

In a case where the first embodiment and the second embodiment are combined, the number of customers prediction device selects the model to be used for each prediction target day according to the acquisition situation of the input information input to the model with the number of in-building people and the acquired information of the input information input to the model without the number of in-building people, and outputs the predicted value of the number of customers output from the selected model as the integrated number of customers predicted value.

Note that, in the above embodiment, the case where the number of customers prediction device 10 executes the model learning processing and the number of customers prediction processing has been described as an example, but the present invention is not limited thereto. For example, a learning device may execute the model learning processing, and the number of customers prediction device may execute the number of customers prediction processing.

The processing executed by the CPU 11 reading the each program in the above embodiment may be executed by various processors other than the CPU 11. Examples of the processors in this case include a programmable logic device (PLD) in which a circuit configuration can be changed after manufacturing, such as a field-programmable gate array (FPGA), or the like, and a dedicated electric circuit, or the like, that is a processor having a circuit configuration exclusively designed for executing a specific process, such as an application specific integrated circuit (ASIC). In addition, each processing may be executed by one of the various processors or may be executed by a combination of two or more processors of the same type or different types (for example, a combination of a plurality of FPGAs or a combination of a CPU and an FPGA). Further, a hardware structure of these various processors is, more specifically, an electric circuit in which circuit elements such as semiconductor elements are combined.

Further, in the above embodiment, the aspect in which the program is stored (also referred to as “installed”) in advance in the ROM 12 or the storage 14 has been described, but the present embodiment is not limited thereto. The number of customers prediction program may be provided in the form of a program stored in a non-transitory storage medium such as a compact disk read only memory (CD-ROM), a digital versatile disk read only memory (DVD-ROM), or a universal serial bus (USB) memory. Furthermore, the program may be downloaded from an external device via a network.

All documents, patent applications, and technical standards described in this specification are incorporated herein by reference to the same extent as when a case where incorporation by reference of each document, patent application, and technical standard is specifically and individually described.

With regard to the above embodiments, the following supplementary notes are further disclosed.

### (Supplement 1)

A number of customers prediction device including:
a memory; and
at least one processor connected to the memory, in which,
in predicting a number of customers of a store located in a building,
the processor is configured to:
   acquire a plurality of explanatory variables including a number of in-building people indicating a number of people existing in the building;
   acquire a first number of customers predicted value by inputting the explanatory variable including the number of in-building people to a first model that outputs the first number of customers predicted value that is a predicted value of the number of customers when the explanatory variable including the number of in-building people is input among the plurality of explanatory variables;
   acquire a second number of customers predicted value by inputting the explanatory variable not including the number of in-building people to a second model that outputs the second number of customers predicted value that is a predicted value of the number of customers when the explanatory variable not including the number of in-building people is input among the plurality of explanatory variables; and
   acquire an integrated number of customers predicted value by inputting the plurality of explanatory variables, the first number of customers predicted value, and the second number of customers predicted value to a third model that outputs the integrated number of customers predicted value that is a predicted value of the number of customers in which the first number of customers predicted value and the second number of customers predicted value are integrated when the plurality of explanatory variables, the first number of customers predicted value, and the second number of customers predicted value are input.

### (Supplement 2)

A non-transitory storage medium storing a program executable by a computer to execute number of customers prediction processing,
the number of customers prediction processing including:
   in predicting a number of customers of a store located in a building,
   acquiring a plurality of explanatory variables including a number of in-building people indicating a number of people existing in the building;
   acquiring a first number of customers predicted value by inputting the explanatory variable including the number of in-building people to a first model that outputs the first number of customers predicted value that is a predicted value of the number of customers when the explanatory variable including the number of in-building people is input among the plurality of explanatory variables;
   acquiring a second number of customers predicted value by inputting the explanatory variable not including the number of in-building people to a second model that outputs the second number of customers predicted value that is a predicted value of the number of customers when the explanatory variable not including the number of in-building people is input among the plurality of explanatory variables; and
   acquiring an integrated number of customers predicted value by inputting the plurality of explanatory variables, the first number of customers predicted value, and the second number of customers predicted value to a third model that outputs the integrated number of customers predicted value that is a predicted value of the number of customers in which the first number of customers predicted value and the second number of customers predicted value are integrated when the plurality of explanatory variables, the first number of customers predicted value, and the second number of customers predicted value are input.

### (Supplement 3)

A learning device including:
a memory; and
at least one processor connected to the memory, in which,
in learning a model that predicts a number of customers of a store located in a building,
the processor is configured to:
   acquire learning data in which a plurality of explanatory variables for learning including a number of in-building people indicating a number of people existing in the building is associated with an actual number of customers; and
   learn, on a basis of the learning data,
   a first model that outputs a first number of customers predicted value that is a predicted value of the number of customers when the explanatory variable including the number of in-building people is input,
   a second model that outputs a second number of customers predicted value that is a predicted value of the number of customers when the explanatory variable not including the number of in-building people is input, and
   a third model that outputs an integrated number of customers predicted value that is a predicted value of the number of customers in which the first number of customers predicted value and the second number of customers predicted value are integrated when a plurality of the explanatory variables, the first number of customers predicted value, and the second number of customers predicted value are input.

### (Supplement 4)

A non-transitory storage medium storing a program executable by a computer to execute number of customers prediction processing,
the learning processing including:
   in learning a model that predicts a number of customers of a store located in a building,
   acquiring learning data in which a plurality of explanatory variables for learning including a number of in-building people indicating a number of people existing in the building is associated with an actual number of customers; and
   learning, on a basis of the learning data,
   a first model that outputs a first number of customers predicted value that is a predicted value of the number of customers when the explanatory variable including the number of in-building people is input,
   a second model that outputs a second number of customers predicted value that is a predicted value of the number of customers when the explanatory variable not including the number of in-building people is input, and
   a third model that outputs an integrated number of customers predicted value that is a predicted value of the number of customers in which the first number of customers predicted value and the second number of customers predicted value are integrated when a plurality of the explanatory variables, the first number of customers predicted value, and the second number of customers predicted value are input.

### REFERENCE SIGNS LIST

10 Number of customers prediction device
100 Data storage unit
102 Learning data acquisition unit
104 Feature amount selection unit
106 Learning unit
108 Model storage unit
110 Acquisition unit
112 Prediction unit

1. A number of customers prediction device comprising:
a memory; and
at least one processor connected to the memory, in which.
in predicting a number of customers of a store located in a building,
the processor is configured to:
acquire a plurality of explanatory variables including a number of in-building people indicating a number of people existing in the building;
acquire a first number of customers predicted value by inputting the explanatory variable including the number of in-building people to a first model that outputs the first number of customers predicted value that is a predicted value of the number of customers when the explanatory variable including the number of in-building people is input among the plurality of explanatory variables;
acquire a second number of customers predicted value by inputting the explanatory variable not including the number of in-building people to a second model that outputs the second number of customers predicted value that is a predicted value of the number of customers when the explanatory variable not including the number of in-building people is input among the plurality of explanatory variables; and
acquire an integrated number of customers predicted value by inputting the plurality of explanatory variables, the first number of customers predicted value, and the second number of customers predicted value to a third model that outputs the integrated number of customers predicted value that is a predicted value of the number of customers in which the first number of customers predicted value and the second number of customers predicted value are integrated when the plurality of explanatory variables, the first number of customers predicted value, and the second number of customers predicted value are input.

2. The number of customers prediction device according to claim 1, wherein
feature amounts representing the plurality of explanatory variables, the first number of customers predicted value, and the second number of customers predicted value input to the third model are feature amounts selected in advance from a plurality of feature amount candidates so as to reduce a difference between the integrated number of customers predicted value and the actual number of customers.

3. The number of customers prediction device according to claim 1, wherein
the third model outputs selection information indicating which of the first model and the second model is to be selected, and
one of the first model and the second model is selected on a basis of the selection information output from the third model, and the predicted value of the number of customers output from the selected model is output as the integrated number of customers predicted value.

4. The number of customers prediction device according to claim 1, wherein the processor is configured to:
use a plurality of models when acquiring the integrated number of customers predicted value; and
select a model to be used for each prediction target day according to an acquisition situation of input information input to the plurality of models, and outputs the predicted value of the number of customers output from the selected model as the integrated number of customers predicted value.

5. (canceled)

6. A number of customers prediction method that predicts a number of customers of a store located in a building, in which a computer executes processing comprising:
by a processor,
acquiring a plurality of explanatory variables including a number of in-building people indicating a number of people existing in the building;
acquiring a first number of customers predicted value by inputting the explanatory variable including the number of in-building people to a first model that outputs the first number of customers predicted value that is a predicted value of the number of customers when the explanatory variable including the number of in-building people is input among the plurality of explanatory variables;
acquiring a second number of customers predicted value by inputting the explanatory variable not including the number of in-building people to a second model that outputs the second number of customers predicted value that is a predicted value of the number of customers when the explanatory variable not including the number of in-building people is input among the plurality of explanatory variables; and
acquiring an integrated number of customers predicted value by inputting the plurality of explanatory variables, the first number of customers predicted value, and the second number of customers predicted value to a third model that outputs the integrated number of customers predicted value that is a predicted value of the number of customers in which the first number of customers predicted value and the second number of customers predicted value are integrated when the plurality of explanatory variables, the first number of customers predicted value, and the second number of customers predicted value are input.

7. (canceled)

8. A non-transitory storage medium storing a program executable by a computer to execute number of customers prediction processing,
the number of customers prediction processing including:
in predicting a number of customers of a store located in a building,
acquiring a plurality of explanatory variables including a number of in-building people indicating a number of people existing in the building:
acquiring a first number of customers predicted value by inputting the explanatory variable including the number of in-building people to a first model that outputs the first number of customers predicted value that is a predicted value of the number of customers when the explanatory variable including the number of in-building people is input among the plurality of explanatory variables;
acquiring a second number of customers predicted value by inputting the explanatory variable not including the number of in-building people to a second model that outputs the second number of customers predicted value that is a predicted value of the number of customers when the explanatory variable not including the number of in-building people is input among the plurality of explanatory variables; and
acquiring an integrated number of customers predicted value by inputting the plurality of explanatory variables, the first number of customers predicted value, and the second number of customers predicted value to a third model that outputs the integrated number of customers predicted value that is a predicted value of the number of customers in which the first number of customers predicted value and the second number of customers predicted value are integrated when the plurality of explanatory variables, the first number of customers predicted value, and the second number of customers predicted value are input.
